(19) United States
(12) Patent Application Publication
(10) Pub. No.: US 2026/0314597 A1
(43) Pub. Date: Oct. 15, 2026

(54) A NOVEL APPROACH TO INTERFERE IN THE PHENYLPROPANOID BIOSYNTHETIC PATHWAY TO REDUCE PINK-RIB DISORDER IN FRESH LETTUCE

(71) Applicant: University of Florida Research Foundation, Inc., Gainesville, FL (US)

(72) Inventors: Jeongim KIM, Gainesville, FL (US); Steven A. SARGENT, Gainesville, FL (US); Catherine E. BELISLE, Gainesville, FL (US); German V. SANDOYA MIRANDA, Gainesville, FL (US)

(21) Appl. No.: 19/119,117

(22) PCT Filed: Nov. 1, 2023
(86) PCT No.: PCT/US2023/078310

§ 371 Date: Apr. 8, 2025

Related U.S. Application Data
(60) Provisional application No. 63/422,526, filed on Nov. 4, 2022.

(51) Int. Cl. A01N 43/38; A01P 21/00

(52) U.S. Cl. CPC A01N 43/38; A01P 21/00

(57) ABSTRACT

In one aspect, the disclosure relates to a method for reducing or delaying pink rib discoloration in lettuce, the method comprising contacting the lettuce with a composition including melatonin and, optionally, DMSO (dimethyl sulfoxide). In an aspect, the lettuce can be Romaine lettuce, Butterhead lettuce, iceberg lettuce, another lettuce, or any combination thereof. In some aspects, contacting the lettuce with the composition comprises immersing the lettuce in the composition. Also disclosed is a method for objectively quantifying the degree of pink rib discoloration in a cut lettuce surface. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/422,526, filed on Nov. 4, 2022, which is incorporated herein by reference in its entirety.

### STATEMENT REGARDING FEDERALLY SPONSORED RESEARCH OR DEVELOPMENT

This invention was made with government support under grant number AM190100XXXXG036 awarded by the United State Department of Agriculture, Agricultural Marketing Service. The government has certain rights in the invention.

### BACKGROUND

Lettuce is a commercially important crop with worldwide production totaling 37.4 billion tons in 2020 (FAOSTAT, 2020). One of the most common physiological disorders is pink rib, a stress-induced pink discoloration of the midrib that develops both pre- and postharvest. It is also known as pinking (Saltveit, 2018a). This disorder develops in response to stresses, including high field temperatures (Jenni, 2005), over-irrigation (Monaghan et al. 2017), harvest of over-mature heads (Hilton et al. 2009), mechanical damage (Pereyra et al. 2005) and high temperature storage conditions (Lopez-Galvez et al. 1996b). The appearance of pink rib leads to a decline in overall visual quality and decreased marketability (Couture et al. 1993; López-Gálvez et al. 1996b). Pink rib develops on several lettuce types, including Butterhead, Cos, Crisphead (iceberg), and Latin. Due to the irreversible damage and difficulty to control pink rib, it is a severe problem for whole head and fresh-cut lettuce growers and handlers (Chiesa, 2003).

Several approaches have been employed to attenuate development of pink rib, including modified atmosphere packaging (MAP; Luna et al. 2016), heat shock (Saltveit and Qin, 2008), anaerobic treatment (i.e., water immersion; Saltveit, 2018b), and exogenous chemical treatments (Tomás-Barberán et al. 1997; Saltveit et al. 2005; Hisaminato et al. 2001; Gawlik-Dziki et al. 2008). In general, these approaches resulted in slight to moderate reduction of pink rib; most notably, MAP inhibited discoloration in fresh-cut lettuce for 11 d under a simulated commercial shipping temperature of 7° C. (Luna et al. 2016).

Natural compounds have been exogenously applied to a variety of crops, attenuating the development of discoloration disorders. For example, L-cysteine (0.1% or 8.3 mM) applied to fresh-cut iceberg lettuce delayed pink rib development (<20% of the midrib surface area) for 6 d at 8° C., while untreated control midribs became discolored after 2 d (Pace et al. 2015). L-cysteine (0.5% or 41.3 mM) treatment also successfully delayed pulp browning in fresh-cut cherimoya for up to 12 d at 0° C. (Campos-Vargas et al. 2008). However, L-cysteine (0.5% or 41.3 mM) was ineffective when applied to fresh-cut fennel during 6 d at 5° C. (Capotorto et al. 2018) or to fresh-cut artichoke, which developed browning or became yellow (Cabezas-Serrano et al. 2013). These studies revealed variable results of L-cysteine to reduce discoloration in lettuce and other crops.

Natural compounds were evaluated in other crops, including serotonin (1 mM solution), which was applied to apple and pear discs for 30 min and inhibited browning for up to 24 h at 4° C.; this treatment was more effective than ascorbic acid (Bajwa et al. 2015). When cassava roots were immersed in melatonin (0.1 mM) solution then sliced and held at 28° C., vascular streaking disorder was delayed twice as long as untreated control slices (12 h vs. 6 h) (Hu et al. 2016). Melatonin (0.4 mM) delayed pericarp browning of whole litchi fruit for 4 d at 25° C. as compared to control fruit (Zhang et al. 2018). However, the potential inhibitory effects of serotonin or melatonin on pink rib in lettuce are unknown.

Despite advances in crop discoloration research, there is still a scarcity of methods useful for potent, effective, consistent, and predictable inhibition of pink rib discoloration in whole head and fresh cut lettuce. These needs and other needs are satisfied by the present disclosure.

### SUMMARY

In accordance with the purpose(s) of the present disclosure, as embodied and broadly described herein, the disclosure, in one aspect, relates to a method for reducing or delaying pink rib discoloration in lettuce, the method comprising contacting the lettuce with a composition including melatonin and, optionally, DMSO (dimethyl sulfoxide). In an aspect, the lettuce can be Romaine lettuce, Butterhead lettuce, iceberg lettuce, another lettuce, or any combination thereof. In some aspects, contacting the lettuce with the composition comprises immersing the lettuce in the composition. Also disclosed is a method for objectively quantifying the degree of pink rib discoloration in a cut lettuce surface.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1F show pink rib discoloration at cut sites during storage at 5° C.: FIGS. 1A-1C=iceberg lettuce; FIGS. 1D-1F=Romaine lettuce. Severity rating images (FIGS. 1A, 1D), subjective ratings (FIGS. 1B, 1E), and a* values (red/green) via digital imaging method (FIGS. 1C, 1F). a* values for iceberg (n=5) and Romaine (n=3) were generated from cut sites with similar initial color. No a* data was collected on unwounded tissues because the method requires a cut site as a guide for pixel extraction. Vertical bars represent±Standard Error (SE). Test 1 as described in the Examples was used for assessment.

FIGS. 2A-2B show phenylalanine ammonia-lyase (PAL) enzyme activity after storage at 5° C. for 5 d for iceberg (FIG. 2A) and Romaine (FIG. 2B) lettuce midribs wounded and treated immediately with L-cysteine (4.1 mM) or melatonin (4.3 mM). Mean±Standard Error (SE) (n=3). Different letters indicate significant differences among treatments within a lettuce type by Tukey's HSD (P<0.05). Test 1 as described in the Examples was used for assessment.

FIGS. 3A-3B show chlorogenic acid concentration after storage at 5° C. for 5 d for iceberg (FIG. 3A) and Romaine (FIG. 3B) lettuce wounded and treated immediately with L-cysteine (4.1 mM) or melatonin (4.3 mM). Mean±SE (n=6). Different letters indicate significant differences among treatments within a lettuce type by Tukey's HSD (P<0.05). Test 2 as described in the Examples was used for assessment.

FIGS. 4A-4B show polyphenol oxidase (PPO) enzyme activity after storage at 5° C. for 5 d for iceberg (FIG. 4A) and Romaine (FIG. 4B) lettuce wounded and treated immediately with L-cysteine (4.1 mM) or melatonin (4.3 mM). Mean±SE (n=6). Different letters indicate significant differences among treatments within a lettuce type by Tukey's HSD (P<0.05). Test 1 as described in the Examples was used for assessment.

FIGS. 5A-5D show pink rib severity images and visual ratings for (FIGS. 5A-5B) iceberg and (FIGS. 5C-5D) Romaine midribs over 5 d of storage at 5° C. after wounding and immediate treatment with serotonin (both) or naringenin (iceberg only). Mean±SE.

FIG. 6 shows a positive correlation between visual pink rib rating and a* value, with P-value calculated via an F-test.

FIGS. 7A-7C are photographs of whole romaine lettuce leaflets wherein midribs were treated with 4.3 mM of melatonin for 1 min and stored at 10° C. for five days. Treated leaflets showed less pink rib discoloration than control samples.

FIGS. 8A-8B are photographs of romaine lettuce midribs treated with 1 mM of melatonin for 1 min and stored for 4 days at 10° C. Treated midribs showed less pink rib discoloration than control samples.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

It has been proposed that pink rib is associated with the polymerization of o-quinones (Hunter et al. 2017; Saltveit, 2018a). O-quinones are highly reactive and polymerize or react with amino acids and proteins to produce pink, brown, and black pigmented compounds (Pierpoint, 1969; Hunter et al. 2017). It was also shown that lettuce midrib tissues exhibiting pink rib symptoms contain higher concentrations of caffeic acid and its derivatives, such as caffeoyltartaric acid and chlorogenic acid (Luna et al. 2016). These phenolic compounds may be associated with pink rib, as their oxidation products from polyphenol oxidase (PPO) are o-quinones (Hapiot et al. 1996; Rawel and John, 2010; Toivonen and Brummell, 2008). Phenylalanine ammonia-lyase (PAL) catalyzes the deamination of phenylalanine to produce cinnamic acid, which is a precursor of various phenylpropanoids, such as chlorogenic acid, and there are several reports of correlation between PAL activity and severity of pink rib (Tanaka et al. 2011; Saltveit, 2018b; Teng et al. 2019). L-cysteine inhibited PPO activity (Altunkaya and Gökmen, 2008) and reduced chlorogenic acid concentration in homogenized lettuce tissue during 24 h at 25° C. (Altunkaya and Gökmen, 2009). Despite these systematic studies, a comprehensive understanding of the biochemistry underlying pink rib discoloration is lacking.

It was previously shown that naringenin represses PAL activity and subsequent development of phenylpropanoids in Arabidopsis thaliana (Yin et al. 2012). Since a positive correlation between PAL activity and pink discoloration has been reported (Tanaka et al. 2011; Saltveit, 2018; Teng et al. 2019), it is possible that naringenin application may inhibit discoloration of lettuce.

Disclosed herein is a method of using exogenously applied natural compounds (L-cysteine, naringenin, serotonin, melatonin) to wounded lettuce midribs to reduce development of pink rib discoloration during simulated commercial storage. In one aspect, as disclosed herein, metabolite changes and enzymatic (PPO and PAL) activity following induction of pink rib discoloration via wounding and immediate application of natural compounds may provide guidance as to specific metabolites, amounts, and timing of administration of the exogenously applied compounds. Also described herein is a comparison of the severity of pink rib symptoms by subjective rating and by objective color imaging.

To standardize evaluations of pink rib, Cantwell (2016) developed a subjective rating scale to mimic mechanical damage that typically occurs in lettuce midribs during harvest, handling, and fresh-cut operations. Midrib sections were wounded and discoloration at the cut surfaces was subjectively rated during storage using a five-point hedonic scale. An alternative, objective method to quantify color is visible imaging, which captures images in the Red, Green, Blue (RGB) color space. This method has been utilized extensively in plant phenomics to measure a variety of phenotypes involving plant color (Yang et al. 2020).

In one aspect, the disclosed method includes the step of contacting the lettuce with a composition including from about 1.0 to about 5.7 mM melatonin, from about 1.0 to about 4.3 mM melatonin, or about 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, or about 5.7 mM melatonin, or a combination of any of the foregoing values, or a range encompassing any of the foregoing values. In one aspect, the composition includes about 4.3 mM of melatonin. In another aspect, the composition also includes DMSO. In one aspect, the DMSO can be from about 0.1 to about 1 vol %, or can be about 0.1, 0.2, 0.3, 0.4, 0.5, 0.6, 0.7, 0.8, 0.9, or about 1 vol %, or a combination of any of the foregoing values, or a range encompassing any of the foregoing values. In an aspect, the DMSO is present at 0.5 vol %.

In another aspect, the lettuce can be Romaine lettuce, Butterhead lettuce, iceberg lettuce, or any combination thereof.

In one aspect, contacting the lettuce with the composition includes immersing the lettuce in the composition, spraying the lettuce with the composition, pouring the composition over the lettuce, or any combination thereof. In an aspect, the lettuce is immersed in the composition for up to about 60 seconds, or for up to about 30 seconds.

In still another aspect, the method reduces or delays pink rib discoloration for from about 3 days to about 5 days, or for 3, 4, or 5 days. In one aspect, the lettuce can be iceberg lettuce and the method reduces or delays pink rib discoloration for about 5 days. In an alternative aspect, the lettuce can be Romaine lettuce, and the method reduces or delays pink rib discoloration for about 3 days.

In any of these aspects, the method further includes storing the lettuce at from about 5° C. to about 25° C., or from about 10° C. to about 25° C., or at about 5° C. after contacting the lettuce with the composition. In still another aspect, the method further includes storing the lettuce at about 95 to about 98% relative humidity after contacting the lettuce with the composition. In one aspect, the method is performed at from about 4 hours to about 3 days following harvest of the lettuce.

Also disclosed herein is a method for assessing pink rib discoloration in cut lettuce surfaces, the method including at least the steps of:
(a) acquiring a digital image of a cut lettuce surface;
(b) extracting an RGB color value from one or more isolated pixels in the digital image;
(c) converting the RGB color value to an L*a*b* color value; and
(d) extracting an a* value from the L*a*b* color value;
   wherein a positive a* value indicates pink rib discoloration is present.

In a further aspect, in this method, a higher magnitude a* value indicates a greater degree of pink rib discoloration.

In one aspect, contacting the lettuce with the composition including melatonin can result in a magnitude of increase in a* value in L*a*b* color space in a digital image of a cut surface of the lettuce of less than about 6 when compared to a digital image of the lettuce prior to contacting the lettuce with the composition including melatonin. In a further aspect, the lettuce can be iceberg lettuce and the magnitude of increase in a* value is less than about 1 after 5 days. In an alternative aspect, the lettuce can be Romaine lettuce and the magnitude of increase in a* value is less than about 5.5 after about 5 days. In any of these aspects, the final a* value after contacting the lettuce with the composition including melatonin is less than about 1.5.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a metabolite,” “a small molecule,” or “an enzyme,” includes, but is not limited to, mixtures or combinations of two or more such metabolites, small molecules, or enzymes, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g. ‘about x, y, z, or less’ and should be interpreted to include the specific ranges of ‘about x,’ ‘about y’, and ‘about z’ as well as the ranges of ‘less than x’, less than y′, and ‘less than z’. Likewise, the phrase ‘about x, y, z, or greater’ should be interpreted to include the specific ranges of ‘about x,’ ‘about y,’ and ‘about z’ as well as the ranges of ‘greater than x,’ greater than y,′ and ‘greater than z.’ In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a small molecule refers to an amount that is sufficient to achieve the desired improvement in the property modulated by the formulation component, e.g. achieving the desired level of reduction of pink rib discoloration. The specific level in terms of wt % in a composition required as an effective amount will depend upon a variety of factors including the amount and type of lettuce, storage temperature of the lettuce, and time since harvest.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric \

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered Aspects, which should not be confused with the claims.

Aspect 1. A method for reducing or delaying pink rib discoloration in lettuce, the method comprising contacting the lettuce with a composition comprising melatonin.

Aspect 2. The method of aspect 1, wherein the lettuce comprises Romaine lettuce, Butterhead lettuce, or iceberg lettuce.

Aspect 3. The method of aspect 1 or 2, wherein the composition comprises from about 1.0 mM to about 5.7 mM of melatonin.

Aspect 4. The method of aspect 3, wherein the composition comprises 4.3 mM of melatonin.

Aspect 5. The method of any one of aspects 1-4, wherein the composition further comprises DMSO.

Aspect 6. The method of aspect 5, wherein the composition comprises 0.5 vol % DMSO.

Aspect 7. The method of any one of aspects 1-6, wherein contacting the lettuce with the composition comprises immersing the lettuce in the composition, spraying the lettuce with the composition, pouring the composition over the lettuce, or any combination thereof.

Aspect 8. The method of aspect 7, wherein the lettuce is immersed in the composition for up to about 60 seconds.

Aspect 9. The method of any one of aspects 1-8, wherein the method reduces or delays pink rib discoloration for from about 3 to about 5 days.

Aspect 10. The method of aspect 9, wherein the lettuce is iceberg lettuce and the method reduces or delays pink rib discoloration for about 5 days.

Aspect 11. The method of aspect 9, wherein the lettuce is Romaine lettuce and the method reduces or delays pink rib discoloration for about 3 days.

Aspect 12. The method of any one of aspects 1-11, wherein the method further comprises storing the lettuce at from about 5 to about 25° C. after contacting the lettuce with the composition.

Aspect 13. The method of any one of aspects 1-12, wherein the method further comprises storing the lettuce at 95-98% relative humidity after contacting the lettuce with the composition.

Aspect 14. The method of any one of aspects 1-13, wherein the method is performed at from about 4 hours to about 3 days following harvest of the lettuce.

Aspect 15. The method of any one of aspects 1-14, wherein performing the method results in a magnitude of increase in a* value in L*a*b* color space in a digital image of a cut surface of the lettuce of less than about 6 after 5 days when compared to a digital image of the lettuce prior to performing the method.

Aspect 16. The method of aspect 15, wherein the lettuce is iceberg lettuce and the magnitude of increase in a* value is less than about 1 after 5 days.

Aspect 17. The method of aspect 15, wherein the lettuce is Romaine lettuce and the magnitude of increase in a* value is less than about 5.5 after 5 days.

Aspect 18. The method of any one of aspects 15-17, wherein a final a* value after performing the method is less than about 1.5.

Aspect 19. The method of any one of aspects 1-18, wherein performing the method reduces formation of o-diphenols, o-quinones, or both.

Aspect 20. A method for assessing pink rib discoloration in cut lettuce surfaces, the method comprising:
(a) acquiring a digital image of a cut lettuce surface;
(b) extracting an RGB color value from one or more isolated pixels in the digital image;
(c) converting the RGB color value to an L*a*b* color value; and
(d) extracting an a* value from the L*a*b* color value;
wherein a positive a* value indicates pink rib discoloration is present.

Aspect 21. The method of aspect 20, wherein a higher magnitude a* value indicates a greater degree of pink rib discoloration.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Materials and Methods

### Plant Material and Experimental Setup

Six preliminary experiments were performed to determine treatment conditions for the three final experiments reported here. It was determined that the method developed by Cantwell (2016) induced pink rib discoloration in lettuce midribs during storage at 5° C. via mimicking mechanical damage and was, therefore, selected for use in all preliminary and final tests. Solution concentrations and submersion times were tested for four compounds to determine the most effective treatment that reduced pink rib discoloration during storage at 5° C. for 5 d. Concentrations evaluated were: L-cysteine (0.4, 0.8, 2.1, 4.1, 8.3 mM), naringenin (0.2, 0.4, 0.9, 1.8, 3.7 mM), serotonin (2.8, 5.7 mM), and melatonin (0.2, 0.4, 1.1, 2.2, 4.3 mM) (data not presented). These tests revealed that concentrations of each compound below 1.8 mM and above 5.7 mM had negligible effect on suppressing pink rib development. Therefore, this study employed the one or two concentrations for each compound with the greatest potential efficacy in three independent tests, Test 1 to 3 (Table 1).

TABLE 1
Lettuce Sources and Description of Evaluation
Methods for the Three Tests

| Test | Lettuce Sources | Evaluation Methods |
|---|---|---|
| Test 1 | Store bought romaine and | Subjective pink rib severity |
| | iceberg (cultivars unknown) | (1- to 5-point scale) |
| | | Objective pink rib severity |
| | | (RGB image analysis) |
| | | Protein quantification |
| | | PAL and PPO activity |
| Test 2 | Romaine (‘Tall Guzmaine’) and | Subjective pink rib severity |
| | iceberg (‘Chosen’) grown in | (1- to 5-point scale) |
| | Belle Glade, FL | Metabolite analysis |
| Test 3 | Romaine (‘Manatee’) grown in | Subjective pink rib severity |
| | Belle Glade, FL | (1- to 5-point scale) |
| | | Untargeted metabolomics |

For Test 1, the evaluations for pink rib development, protein quantification, and enzyme activity were conducted with Romaine and iceberg lettuce heads (36 heads per type; cultivars unknown) purchased (February 2020) upon arrival at a local grocery store in Gainesville, FL, and immediately transported to the Postharvest Horticulture Laboratory at the University of Florida in Gainesville, FL. For Test 2, metabolite extraction and detection were conducted with commercially grown, harvested, and cooled Romaine (‘Tall Guzmaine’) and iceberg (‘Chosen’) lettuce (December 2020) grown in Belle Glade, FL. For Test 3, untargeted metabolomics was performed using commercially grown, harvested, and cooled Romaine (‘Manatee’) lettuce grown in Belle Glade, FL (April 2021). To keep the lettuce head samples cool while preventing freeze damage during transport, a 3- to 6-inch layer of crushed ice was placed on the bottom of each 114-L cooler. A piece of waxed, corrugated fiberboard was placed on top of the ice prior to packing with the lettuce samples for transport the same day to the Postharvest Horticulture Laboratory in Gainesville (approximately 4 h distant).

In all tests, experimental setup began immediately upon arrival to the laboratory. 90 outer leaves were randomly selected from 18 to 22 lettuce heads that met commercial and damage-free quality standards. A midrib segment (12.5 cm) was excised from the center of each leaf and excess leaf blade tissue was trimmed parallel to the midrib. This procedure was adapted from the wounding procedure of Cantwell (2016). Each midrib was then partially sliced transversally at 1.3-cm increments along the midrib. Midribs (n=15) were immediately immersed for 30 s in one of five treatment solutions: deionized water (wounded control), L-cysteine (4.1 mM), naringenin (1.8 mM) with 20% dimethyl sulfoxide (DMSO), serotonin (2.8 or 5.7 mM) or melatonin (4.3 mM) with 0.50% DMSO. Immediately following immersion, the midribs for each treatment were patted dry using paper towels and placed (n=5) in a breathable, high-density polyethylene bag (n=3) (Narrow Profile Produce Bags [14×18 inches] Model No. S-19156, Uline®, Pleasant Prairie, WI). Unwounded control midribs were stored in the same manner. To allow for direct comparison, each cut site on each midrib was assigned an initial discoloration value on day 1 based on the coloration of the rib. Samples were stored at 5° C. with 95-98% relative humidity (RH) for 5 d, simulating commercial storage.

### Preparation of the Solutions

All chemicals were of laboratory or reagent grade from Alfa Aesar (Thermo Fisher Scientific, Ward Hill, MA, USA) or Phyto Technology Laboratories (Shawnee Mission, KS, USA). L-cysteine (4.1 mM) solution was prepared by dissolving 500 mg of L-cysteine in 100 ml deionized water. Naringenin (1.8 mM) solution was prepared by dissolving 500 mg of naringenin in 20 mL of DMSO and diluting to a 100 mL volume with deionized water. A stock solution of serotonin (5.7 mM) was prepared by dissolving 100 mg of serotonin in 100 ml of deionized water; a second solution of serotonin (2.8 mM) was prepared by diluting the stock solution two-fold with deionized water. A 4.3-mM solution of melatonin was prepared by dissolving 100 mg of melatonin in 0.5 mL of DMSO and diluting to a 100 mL volume with deionized water. Ranges of concentrations of each stock solution were then prepared for each compound.

### Evaluation of Pink Rib Development

Midrib samples were evaluated for pink rib severity after 1, 3, and 5 d of storage in Tests 1, 2, and 3 (Table 1). Subjective ratings were based on a 1- to 5-point scale after Cantwell (2016), where 1=no discoloration, 2=slight, 3=moderate, 4=moderately severe, and 5=severe. Signs of visual decline (wilting, shriveling, toxicity) and decay were noted when present. At the 5-d evaluation, the midrib tissues (500-800 mg) were excised, frozen in liquid nitrogen, and stored at −80° C. for later analysis.

Objective evaluations were also made after 1, 3, and 5 d by capturing an image of each wounded midrib using a digital camera (Nikon D5200, Nikon, Melville, NY, USA) under full spectrum LED lighting (Sunco Lighting, Valencia, CA, USA) with 4100 Lumens at a distance of 1.12 m. Only unwounded and treated (L-cysteine or melatonin) midribs from Test 1 were measured using this method. The camera settings were on manual mode ISO400, shutter speed 1/125, aperture 5.6, and no zoom or flash; distance from the tissue was approximately 18 inches. The white balance of the camera was set with a gray card prior to each imaging session. GNU Image Manipulation Program (GIMP, version 2.10.14; The GIMP Project c/o GNOME Foundation, Orinda, CA, USA) was used to isolate pixels from an area 1 mm in width along the length of each cut site. Because a cut site is required as a guide for pixel extraction, no data was collected from images of the unwounded midribs.

Isolated pixels were converted from the RGB to the L*a*b* color space (Commission Internationale de l'Elcairage) with the “convertColor” function in R version 4.0.0 (R Core Team, 2020), using Illuminant D65 as the white reference. The mean a* value was calculated for each group of isolated cut site pixels at each time point. In the L*a*b* color space, r represents the degree of redness (+) or greenness (−); thus, the mean a* at each cut site quantified the severity of pink rib discoloration. R was also applied to subset the data, to ensure that the cut sites chosen for further analysis had similar initial color. The a* values ranged from −3 to 0 for iceberg lettuce and −6 to −3 for Romaine.

### Metabolite Analysis

Unwounded, wounded, and compound-treated wounded midrib samples were collected for untargeted metabolite analysis to identify global metabolite changes in response to melatonin application and targeted metabolite analysis to quantify chlorogenic acid a major caffeoyl compound in lettuce. For both targeted and untargeted metabolite analyses, fresh samples (500-800 mg) of the midribs from each treatment (n=3) were weighed, then immediately frozen in liquid nitrogen and stored at −80° C. for subsequent metabolite extraction. Frozen samples were extracted with a 50% methanol extraction solution containing a 1:1 (v:v) of methanol with deionized water. Samples were completely submerged in a 1:1.5 (w:v) of the sample weight (mg) to extraction solution volume (μL), respectively, and incubated at 65° C. for 90 min and then centrifuged at 9660×g for 10 min (MC-12 High Speed Micro Centrifuge, Benchmark Scientific, Edison, NJ). The supernatant was transferred to a new tube and filtered with a 0.45 μm filter (Choice, Thermo Scientific, Wilmington, DE). An aliquot of 400 μL was vacuum-dried.

For chlorogenic acid quantification, vacuum-dried samples were resuspended with 50 μL of 50% methanol. A 10 μL volume of extract was analyzed on an UltiMate 3000 High Performance Liquid Chromatography (HPLC) system (Thermo Fisher Scientific, Ward Hill, MA, USA) equipped with a diode array detector (DAD) in the UV-VIS region 200 to 500 nm. The compounds were separated on an Acclaim™ RSLC PA2 column (150 mm×2.1 mm; 2.2 μm) (Thermo Fisher Scientific, Ward Hill, MA, USA) coupled with a C18 guard column (10 mm×3 mm; 5 μm). The mobile phase consisted of solvent A (0.1% formic acid (v/v) in water) and solvent B (100% acetonitrile), and the gradient as follows: 5% to 20% increase of solvent B at 0.3 to 0.4 min, 20% to 25% increase solvent B at 5.25 to 12.5 min, 25% to 95% increase solvent B at 12.5 to 16.5 min, and 95% solvent B at 16.5 to 20 min. The flow rate was 0.4 mL min⁻¹ and the column temperature was 40° C. The level of chlorogenic acid was quantified based on the peak area at 328 nm and the standard curve using authentic standard (Sigma Aldrich; St. Louis, MO, USA).

For untargeted metabolite analysis, vacuum-dried samples were resuspended into 100 μL of 50% methanol solution containing an internal standard umbelliferon (18 μg mL⁻¹) and vortexed for 1 min. After centrifugation at 13,000×g for 15 min, the solutions were transferred to sample inserts and analyzed. Liquid chromatography/tandem mass spectrometry LC-MS/MS analysis was performed in both negative and positive mode on a Bruker maXis impact quadrupole-time-of-flight mass spectrometer coupled to a Waters ACQUITY ultrahigh performance liquid chromatography (UPLC) system (UPLC-Q-TOF-MS/MS). Separation was achieved on a Waters C18 column (2.1×150 mm, BEH C18 column with 1.7-μm particles) using a linear gradient and mobile phase A (0.1% formic acid) and B (B: acetonitrile). Gradient condition: B increased from 5% to 70% over 30 min, then to 95% over 3 min, held at 95% for 3 min, then returned to 5% for equilibrium. The flow rate was 0.56 mL min⁻¹ and the column temperature was 60° C. Mass spectrometry was performed in the positive electrospray ionization mode with the nebulization gas pressure at 43.5 psi, dry gas of 12 L min⁻¹, dry temperature of 250° C. and a capillary voltage of 4000V. Auto MS/MS Mass spectral data were collected using the following parameters: MS full scan: 100 to 1500 m/z; number of precursors for MS/MS: 3; threshold: 10 counts; active exclusion: 3 spectra, released after 0.15 min; collision energy: dependent on mass, 10 eV at 50 Da, 20 eV at 200 Da, 30 at 500 Da, 40 eV at 1000 Da, and 50 eV at 1500 Da. The MS and MS/MS data were auto-calibrated using sodium formate, which was introduced at the end of the gradient after data acquisition. Data were processed using MetaboScape (Bruker). Metabolites were putatively identified by matching their tandem spectral data against a custom tandem spectral library (Lei et al, 2018), RIKEN spectral library, and NIST20 high resolution accurate mass library (hr_msms_nist). Multivariate analysis was performed using MetaboAnalyst.

### Crude Protein Preparation and PAL Activity

PAL activity was measured using a crude protein extraction following a method reported by Kim et al. (2020) with some modifications. Fresh lettuce samples (300 mg) were ground with liquid nitrogen in a pre-chilled mortar and pestle. A 0.1 mM Tris-HCl buffer (pH 8.3) was added at a 1:1 (w:v). The solution was incubated at 4° C. for 1 h and then centrifuged at 4° C., 9660×g for 15 min. Supernatants were collected in chilled tubes. Total protein content was measured using Quick Start Bradford protein assay kit (Bio-Rad, Hercules, CA, USA) and Bovine Serum Albumin (BSA) as a standard (10 mg mL⁻¹ in deionized water). Protein concentration was calculated based on the absorbance at 595 nm measured with a NanoDrop (One Microvolume UV-Vis Spectrophotometer, Thermo Scientific, Wilmington, DE, USA) and the standard curve. For the PAL activity test, 150 μL aliquots of the protein extract were incubated in a reaction buffer containing 0.1 mM Tris-HCl buffer (pH 8.3), 5 mM dithiothreitol (DTT), and 5 mM phenylalanine. Reaction mixtures were incubated at 37° C. for 90 min and stopped with the addition of 40 μL of 30% acetic acid. Reaction products were extracted with 600 μL of ethyl acetate and then centrifuged at 22° C., 9660×g for 5 min. The supernatant was dried in a speed vac and re-dissolved in 100 μL of 50% methanol. The final extract (10 μL) was analyzed by HPLC using the method previously described in Section 2.4.

### PPO Activity

PPO activity was prepared and determined as reported by Teng et al. (2019) with slight modifications. Lettuce samples (300 mg) were homogenized in 150% (w/v) chilled phosphate buffer (pH 6.2, 0.05 M). Following chilling of test tubes with samples in an ice bath, samples were centrifuged at 9660×g for 10 min at 4° C. The increase in absorbance was measured every 3 s for 1 min. The slope of the linear portion of the time curve was calculated. One unit (U) of PPO activity was defined as an increase in OD₄₁₀ of 0.1 unit within 1 min.

### Statistical Analysis

The imaging data (a* value), enzyme activity (PAL and PPO), and metabolite (chlorogenic acid) results were expressed as mean±standard error and analyzed by lettuce type (iceberg or Romaine). For imaging data, an unpaired t-test was used to identify differences within a treatment throughout storage and among treatment groups at each time point. Treatment groups were defined as wounded, unwounded, L-cysteine, and melatonin. Naringenin and serotonin were not evaluated for imaging due to an unsuccessful reduction of pink rib severity. Analyses of variance were performed for PAL, PPO, and metabolite analyses using SAS software (version 9.4; SAS Institute, Cary, NC) to identify differences among treatment groups. Differences among treatments groups were separated by Tukey's Honest Significant Difference (HSD) test with a confidence level of 95%. The correlation between visual rating and a* value was evaluated for significance via an F-test, from which the P-value of the correlation was calculated.

### Example 2: Results

The results include data from three lettuce harvests (Table 1), as previously mentioned in the Material and Methods section. To standardize findings, sample preparation and subjective evaluations were repeated in all experiments (not all data shown); the results presented were divided into three separate tests with evaluations of pink rib development, protein quantification, and enzyme activity conducted in Test 1, metabolite extraction and detection in Test 2, and untargeted metabolomics in Test 3.

### Visual Evaluations for Pink Rib Discoloration

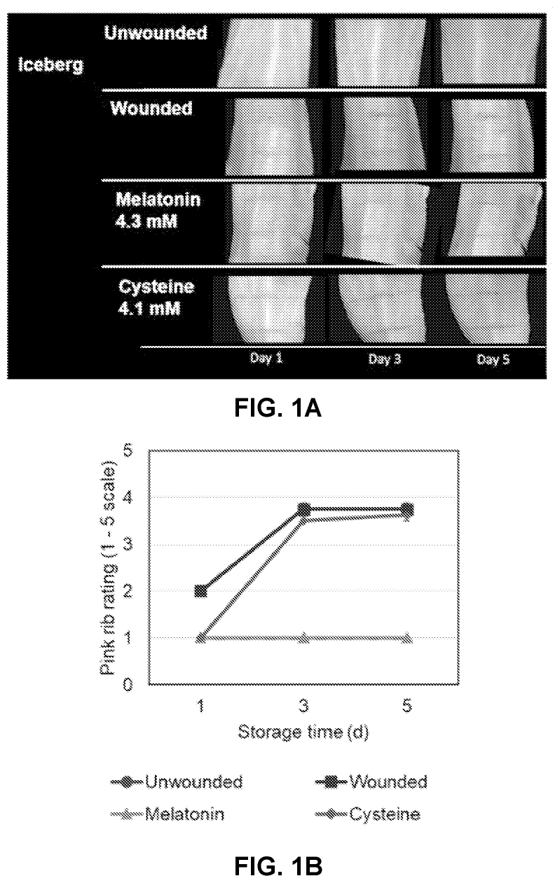

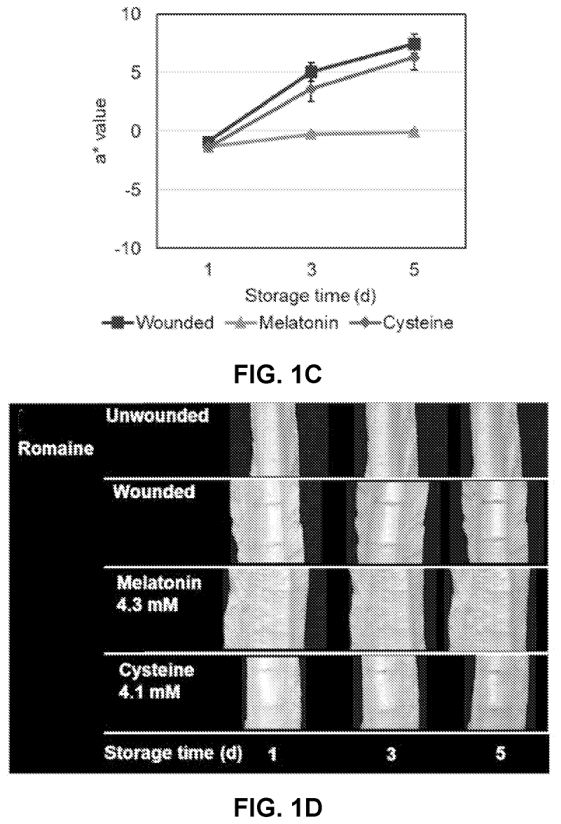

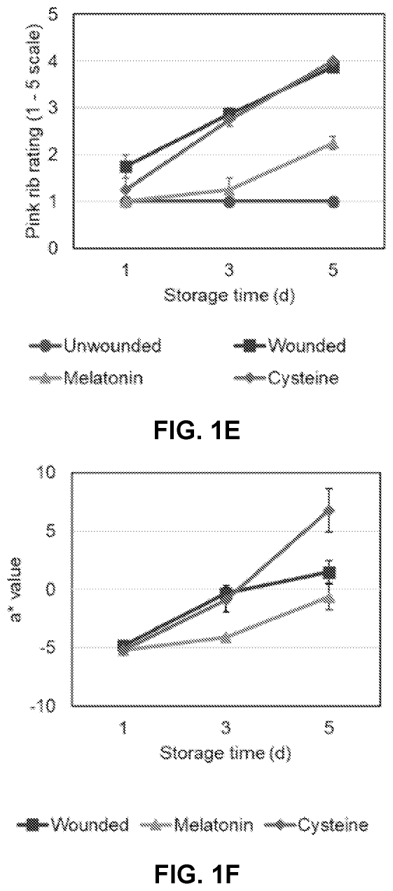

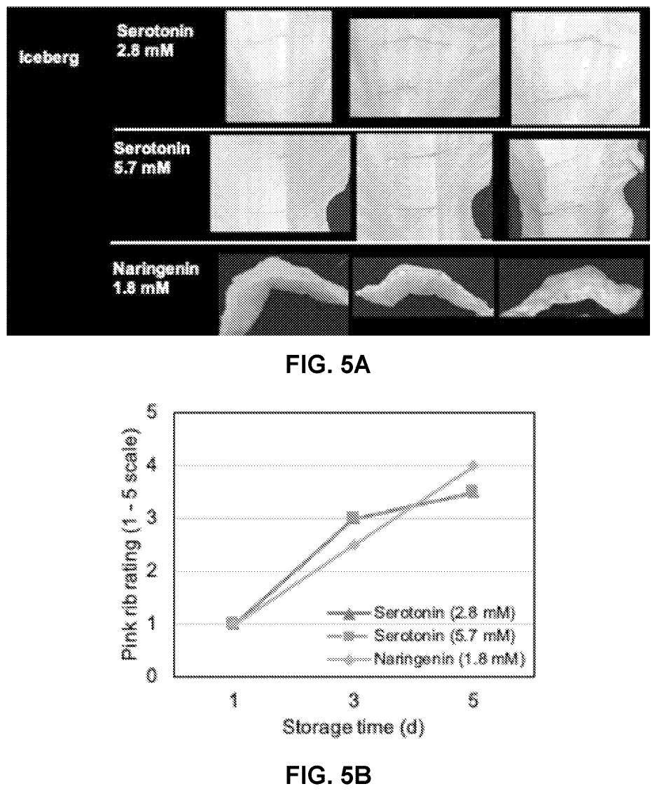

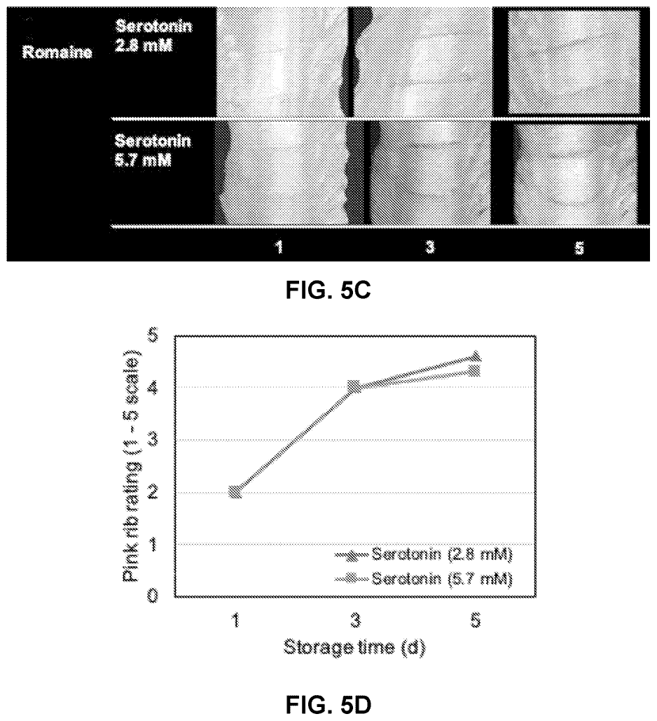

In Test 1, unwounded iceberg and Romaine lettuce midribs did not develop pink rib symptoms whereas symptoms in wounded control midribs increased dramatically during 5 d of storage at 5° C. (FIGS. 1A-1B and 1D-1E). Midrib discoloration in both iceberg and Romaine lettuce increased from “no discoloration” (rating=1) to “moderately severe” (rating=3.8) (FIGS. 1B and 1E, respectively). Likewise, the a* values of wounded control midribs significantly increased (from green to red) throughout storage from an initial of −0.89 to 7.46 in iceberg type and from −4.84 to 1.49 in Romaine type (FIGS. 1C and 1F, respectively). Visual ratings and a* values were positively correlated (R²=0.66, P=0.00004; FIGS. 5A-5D).

### Exogenously Applied Compounds Effect on Development of Pink Rib

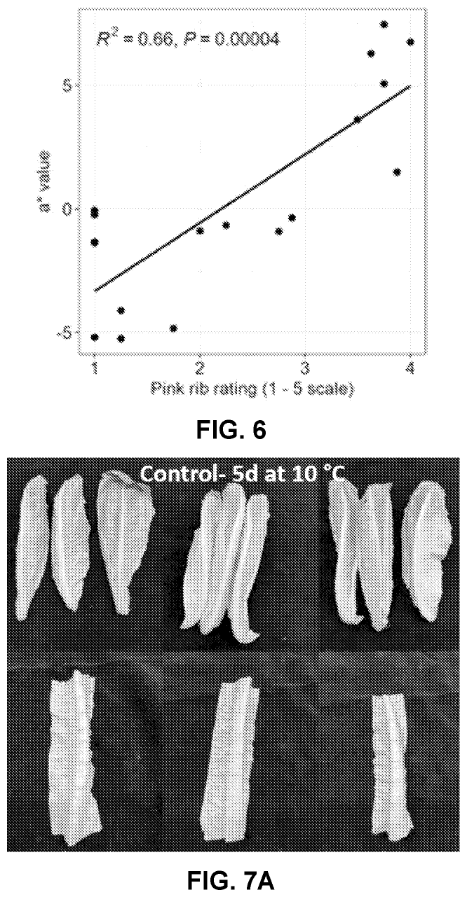

During 5 d at 5° C., midribs treated with serotonin (2.8 or 5.7 mM) developed “moderate” pink rib and yellowing in iceberg lettuce and “moderately severe” pink rib in Romaine lettuce. Naringenin (1.8 mM) application to iceberg midribs was equally unsuccessful with “moderately severe” pink rib development after 5 d at 5° C. (FIG. 6), and L-cysteine application had negligible effect on reducing pink rib. However, melatonin application results were promising as ratings remained equal to or similar to unwounded controls (FIGS. 1B and 1E).

Based on these results, only pink rib development in midribs treated with melatonin or L-cysteine were subsequently compared with unwounded and wounded controls over 5 d at 5° C. (FIGS. 1A-1F). L-cysteine (4.1 mM) treated midribs developed equal or greater discoloration in iceberg and Romaine lettuce as compared with wounded controls (FIGS. 1A and 1D); the a* values (calculated from the images) in wounded and L-cysteine-treated iceberg midribs increased after 3 d (P=0.0242) and 5 d (P=0.00059) (FIG. 1C). In Romaine lettuce, a similar trend was observed, with an increase in wounded and L-cysteine-treated midribs after 3 d (P=0.0242; FIG. 1F). L-cysteine treated midribs developed significantly higher discoloration than the control after 5 d.

Lettuce midribs treated with melatonin (4.3 mM) had dramatically less pink rib discoloration compared with the wounded control. This was consistent across storage time for iceberg type, while Romaine developed a slight discoloration over 5 d (P=0.0058; FIGS. 1A and 1D). The a* values aligned well with visual ratings; in iceberg midribs treated with melatonin, the a* value did not increase throughout storage (FIG. 1C). However, treated Romaine lettuce midribs exhibited increasing a* values between days 3 and 5, at which point the a* values of the control and melatonin-treated midribs were no longer significantly different, with mean a* values of 1.49 and −0.67, respectively (FIG. 1F). Overall, melatonin treatment of iceberg and Romaine lettuces resulted in significantly lower a* values as compared with midribs from the control treatments.

### PAL Activity

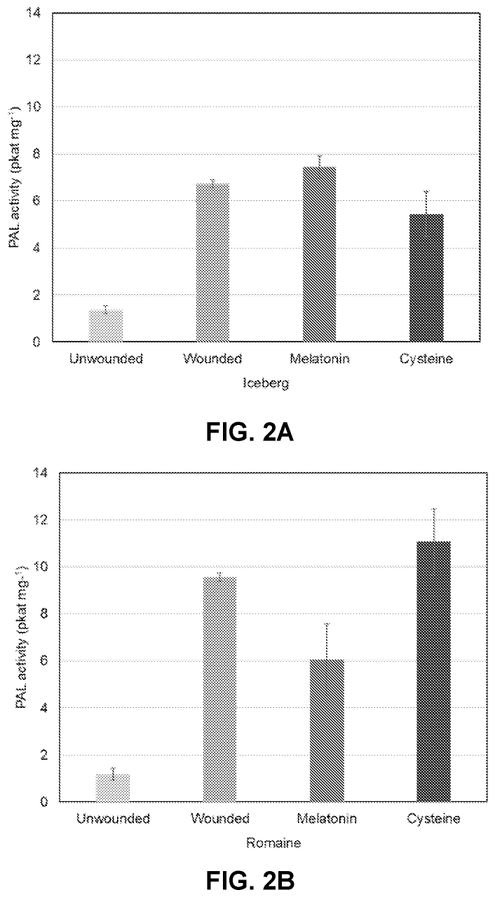

In Test 1, after 5 days at 5° C. PAL activity in wounded midribs was significantly higher than in unwounded midribs for both iceberg (6.73 versus 1.38 pkat mg⁻¹, respectively; P=0.0002) and Romaine (9.56 versus 1.18 pkat mg⁻¹, respectively; P=0.0007) (FIGS. 2A-2B).

When compared with wounded control midribs, those treated with L-cysteine or melatonin showed no significant reduction in PAL activity for iceberg (P=0.3995; P=0.8014, respectively) or Romaine (P=0.7399; P=0.1603, respectively). For iceberg, PAL activity increased to 7.44 pkat mg⁻¹ in melatonin-treated midrib tissue and 5.43 pkat mg⁻¹ in L-cysteine-treated tissue. For Romaine, PAL activity reached 6.06 pkat mg⁻¹ in melatonin-treated midrib tissue and 11.07 pkat mg⁻¹ in L-cysteine-treated tissue. These results suggest that the effect of melatonin and L-cysteine in suppressing expression of pink rib is not a result of inhibition of PAL activity.

### Chlorogenic Acid Content

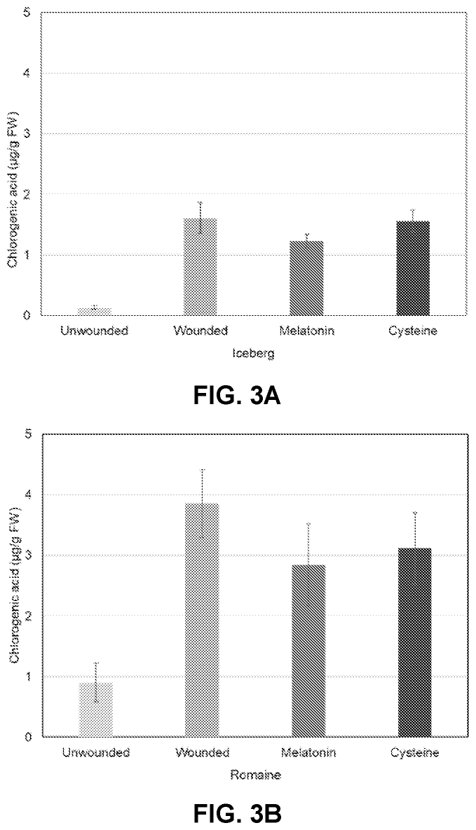

Similar to the results for PAL activity, wounding significantly increased chlorogenic acid concentration compared with the unwounded control in Test 2 for both iceberg (1.61 and 0.13 μg g⁻¹; P=0.0031) and for Romaine midribs (3.86 and 0.91 μg g⁻¹) (P=0.0732) (FIGS. 3A-3B).

However, neither L-cysteine nor melatonin significantly reduced chlorogenic acid concentration for iceberg (1.55 μg g⁻¹) or Romaine (3.11 μg g⁻¹) which was similar to that of wounded midribs in iceberg (1.23 μg g⁻¹) or Romaine (2.84 μg g⁻¹) (FIGS. 3A-3B). When comparing iceberg and Romaine lettuce, the chlorogenic acid concentration was consistently higher in Romaine lettuce, regardless of treatment. These results suggest that the inhibitory effect of melatonin or L-cysteine in suppressing expression of pink rib is not directly associated with chlorogenic acid formation.

### PPO Activity

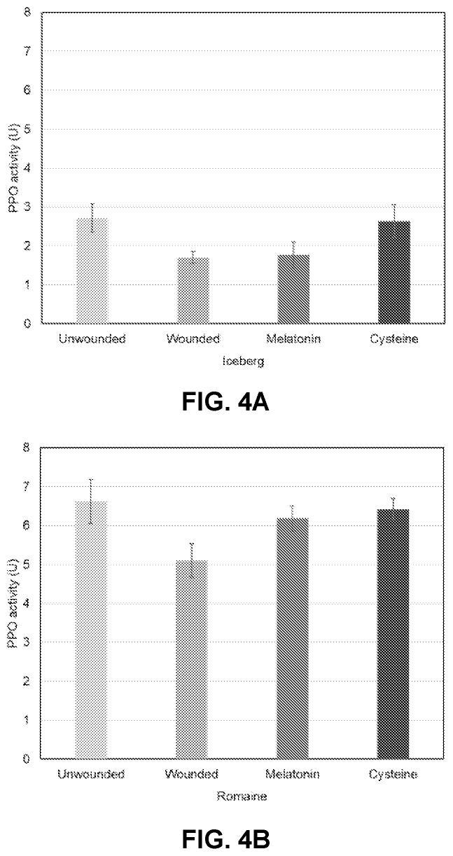

Due to its reported association with pink rib discoloration, PPO activity was examined after 5 d at 5° C. in Test 1 for wounded, unwounded, L-cysteine-, or melatonin-treated midrib tissue. There were no significant differences in PPO activity due to wounding alone, treatment with L-cysteine or melatonin, or lettuce type. Unwounded and wounded controls did not significantly differ in PPO activity for iceberg (2.7 to 1.7 U, respectively; P=0.0733) or for Romaine (6.6 to 5.1 U, respectively; P=0.0772) midribs (FIGS. 4A-4B).

L-cysteine or melatonin treatments had no effect on PPO activity within midribs in iceberg (P=0.0733) or Romaine (P=0.0772). For iceberg, PPO activity was 2.6 U in melatonin-treated and 2.6 U in L-cysteine-treated tissues; in Romaine, PPO activity was 6.2 U in melatonin-treated and 6.4 U in L-cysteine-treated tissues. These results suggest that the effect of melatonin and L-cysteine in suppressing expression of pink rib is not a result of inhibition of PPO activity.

### Analysis of Metabolites Potentially Related to Melatonin Application

In Test 3, untargeted phenolic metabolite analysis was conducted using three groups of samples (unwounded, wounded, and melatonin-treated wounded samples). Among detected metabolites from LC/MS analysis, 93 compounds showed statistically significant (P<0.05) changes in wounded samples compared with unwounded samples, but their abundance was affected by melatonin treatment. Of these metabolites, 68 increased in wounded samples (Table 2), while 25 displayed decreased abundance (Table 3) compared with unwounded samples. Among the 68 accumulated compounds, the majority (64 compounds) were reduced in abundance upon melatonin application, while only four compounds maintained high abundancy (Table 2). Similarly, 16 compounds out of 25 diminished compounds increased abundance with melatonin treatment, and 9 compounds remained in decreased abundance compared with untreated wounded samples (Table 3). This suggests that melatonin application may shift the chemical compositions arising from wounding, which can be potentially related to pink rib. Chlorogenic acid (Table 2) was significantly (P<0.05) accumulated in wounded samples compared to unwounded yet remained similar when compared to melatonin-treated samples, which is consistent with the HPLC results (FIGS. 3A-3B). Notably, several compounds affected by melatonin application were identified to be flavonoids.

TABLE 2
Selected metabolites that increased in response to lettuce midrib wounding [log₂(W/U)]
and were affected by melatonin treatment as identified by untargeted LC-MS/MS

| | Retention | | | | | | | |
|---|---|---|---|---|---|---|---|---|
| Ion | Time | Exact | W/U^{b} | | M/W^{b} | | | |
| Mode^{a} | (min) | Mass | log₂^{c} | P-value^{d} | log₂^{c} | | P-value^{d} | Predicted Compounds |
| + | 3.67 | 634.03 | 9.07 | 2.39E−03 | −2.4 | (↓) | 7.58E−03 | |
| − | 17.26 | 337.86 | 8.65 | 4.92E−03 | −8.65 | (↓) | 4.92E−03 | |
| + | 0.07 | 162.94 | 8.56 | 3.37E−02 | −0.17 | (↓) | 8.20E−03 | |
| − | 15.17 | 181.9 | 8.49 | 1.78E−02 | −8.49 | (↓) | 1.78E−02 | |
| − | 4.97 | 300.02 | 8.32 | 5.55E−03 | −1.97 | (↓) | 3.41E−02 | |
| + | 19.49 | 263.87 | 8.31 | 4.14E−02 | −8.31 | (↓) | 4.14E−02 | |
| − | 0.45 | 181.9 | 7.71 | 2.09E−02 | −7.71 | (↓) | 2.09E−02 | |
| − | 4.42 | 434.21 | 7.54 | 1.38E−02 | −7.54 | (↓) | 1.38E−02 | |
| − | 4.97 | 531.99 | 5.46 | 9.01E−03 | −1.89 | (↓) | 2.57E−02 | |
| − | 4.97 | 677.92 | 5.37 | 2.03E−02 | −1.75 | (↓) | 3.84E−02 | |
| − | 3.65 | 555.12 | 5.11 | 5.50E−03 | −1.97 | (↓) | 4.62E−02 | |
| − | 4.97 | 478.07 | 4.61 | 3.27E−02 | −2.02 | (↓) | 1.76E−02 | Quercetin-3-O-glucuronide; |
| | | | | | | | | PlaSMA ID-1320 |
| + | 3.67 | 332.05 | 4.22 | 1.82E−02 | −2.47 | (↓) | 1.25E−02 | Gossypetin 3-methylether |
| − | 4.09 | 153.01 | 4.15 | 4.84E−03 | −3.57 | (↓) | 4.96E−03 | |
| + | 3.67 | 318.04 | 4.06 | 7.54E−03 | −2.42 | (↓) | 1.16E−02 | Myricetin |
| + | 3.67 | 272.04 | 4.01 | 1.43E−02 | −2.37 | (↓) | 3.70E−03 | |
| − | 4.09 | 109.02 | 3.98 | 1.00E−03 | −3.4 | (↓) | 3.39E−02 | |
| − | 1.44 | 126.02 | 3.93 | 1.27E−02 | −2.4 | (↓) | 1.50E−02 | |
| − | 1.44 | 446.06 | 3.93 | 4.20E−02 | −2.69 | (↓) | 4.10E−02 | |
| + | 3.2 | 272.04 | 3.92 | 3.60E−02 | −3.05 | (↓) | 4.96E−02 | |
| + | 5.65 | 302.04 | 3.89 | 1.26E−02 | −1.73 | (↓) | 1.34E−02 | |
| − | 4.11 | 168.04 | 3.88 | 1.88E−02 | −2.97 | (↓) | 2.85E−02 | Methyl 3,4- |
| | | | | | | | | dihydroxybenzoate |
| + | 5.66 | 550.1 | 3.82 | 2.36E−02 | −1.86 | (↓) | 2.02E−02 | Quercetin-3-(6″-malonyl)- |
| | | | | | | | | Glucoside |
| + | 5.86 | 548.09 | 3.79 | 2.49E−02 | −2.03 | (↓) | 9.41E−03 | |
| − | 3.69 | 598.11 | 3.76 | 2.33E−02 | −2.41 | (↓) | 4.78E−02 | |
| − | 3.67 | 698.03 | 3.67 | 1.31E−02 | −2.09 | (↓) | 3.33E−02 | |
| − | 5.63 | 649.01 | 3.63 | 2.31E−02 | −1.7 | (↓) | 3.94E−02 | |
| + | 5.64 | 604.02 | 3.5 | 2.07E−02 | −1.73 | (↓) | 3.21E−02 | |
| + | 5.64 | 303.05 | 3.48 | 2.05E−02 | −1.74 | (↓) | 2.04E−02 | |
| − | 3.7 | 554.12 | 3.42 | 2.10E−02 | −2.3 | (↓) | 4.52E−02 | |
| + | 5.64 | 621.02 | 3.35 | 2.28E−02 | −1.69 | (↓) | 2.50E−02 | |
| − | 5.67 | 504.08 | 3.25 | 2.83E−02 | −1.32 | (↓) | 4.42E−02 | |
| − | 1.77 | 276.1 | 3.24 | 3.09E−02 | 1.05 | (↓) | 2.13E−02 | |
| + | 4.11 | 136.02 | 3.18 | 1.49E−02 | −2.62 | (↓) | 1.15E−02 | |
| − | 3.75 | 932.22 | 2.52 | 4.96E−02 | −2.35 | (↓) | 4.53E−02 | |
| + | 4.11 | 261.98 | 2.35 | 1.02E−02 | −2.28 | (↓) | 4.66E−03 | |
| − | 5.41 | 582.12 | 2.35 | 2.77E−02 | −2.35 | (↓) | 9.91E−03 | |
| − | 5.41 | 538.13 | 2.15 | 4.02E−02 | −1.97 | (↓) | 3.25E−02 | |
| − | 2.76 | 174.01 | 2.07 | 3.25E−02 | −0.78 | (↓) | 4.82E−02 | |
| − | 5.19 | 458.08 | 1.97 | 2.59E−02 | −1.96 | (↓) | 6.09E−03 | |
| − | 5.2 | 296.05 | 1.94 | 1.58E−02 | −1.99 | (↓) | 3.15E−02 | |
| + | 4.21 | 146.04 | 1.69 | 2.07E−02 | −1.23 | (↓) | 5.45E−03 | Chromone |
| + | 4.23 | 303.98 | 1.59 | 2.53E−04 | −0.23 | (↓) | 4.70E−02 | |
| − | 8.06 | 548.28 | 1.57 | 8.51E−03 | −1.52 | (↓) | 3.10E−02 | |
| − | 2.16 | 164.04 | 1.51 | 3.40E−02 | −1.41 | (↓) | 4.36E−02 | 3-(4-Hydroxyphenyl)prop- |
| | | | | | | | | 2-enoic acid |
| − | 5.21 | 278.04 | 1.47 | 4.37E−02 | −1.47 | (↓) | 1.56E−02 | |
| − | 8.72 | 592.27 | 1.45 | 1.72E−03 | −0.71 | (↓) | 4.30E−02 | |
| − | 1.24 | 333.11 | 1.23 | 3.88E−02 | −0.72 | (↓) | 1.70E−02 | |
| − | 2.16 | 150.01 | 1.2 | 4.85E−02 | −1.19 | (↓) | 3.39E−02 | |
| − | 3.04 | 324.14 | 1.17 | 3.20E−02 | −0.73 | (↓) | 3.08E−02 | C13H24O9; PlaSMA ID- |
| | | | | | | | | 687 |
| − | 7.28 | 278.04 | 1.17 | 3.82E−03 | −2.11 | (↓) | 2.54E−02 | |
| + | 5.22 | 162.04 | 1.15 | 2.22E−02 | −0.92 | (↓) | 3.29E−02 | |
| − | 8.28 | 278.04 | 1.04 | 1.80E−02 | −2.35 | (↓) | 2.09E−02 | |
| − | 1.5 | 178.02 | 1.02 | 4.27E−02 | −0.57 | (↓) | 7.86E−03 | |
| + | 7.84 | 482.06 | 0.95 | 3.64E−02 | 1.2 | (↑) | 3.57E−02 | |
| − | 1.3 | 310.03 | 0.92 | 2.17E−02 | −1.11 | (↓) | 5.70E−03 | |
| − | 2.76 | 344.09 | 0.87 | 4.86E−02 | −0.33 | (↓) | 2.72E−02 | |
| − | 4.16 | 432.19 | 0.83 | 9.11E−03 | −1.29 | (↓) | 1.38E−02 | |
| − | 0.67 | 305.99 | 0.74 | 1.91E−02 | 0.6 | (↑) | 3.30E−03 | |
| − | 1.47 | 316.07 | 0.68 | 1.24E−02 | −0.76 | (↓) | 1.09E−02 | Benzoic acid + 2O, O-Hex; |
| | | | | | | | | PlaSMA ID-666 |
| − | 0.67 | 401.95 | 0.67 | 4.43E−02 | −0.32 | (↓) | 4.03E−02 | |
| − | 1.27 | 178.02 | 0.64 | 1.38E−02 | −0.73 | (↓) | 4.98E−02 | |
| + | 7.84 | 248.05 | 0.57 | 1.09E−02 | 0.71 | (↓) | 2.16E−04 | |
| − | 0.83 | 288.96 | 0.55 | 4.95E−03 | −0.87 | (↓) | 2.77E−02 | |
| − | 31.61 | 385.16 | 0.5 | 8.43E−03 | −0.48 | (↓) | 3.51E−02 | |
| + | 5.79 | 612.4 | 0.48 | 1.66E−02 | −0.68 | (↓) | 2.95E−02 | |
| − | 16.82 | 375.25 | 0.14 | 3.44E−02 | 0.3 | (↑) | 4.64E−02 | |
| − | 0.67 | 134.01 | 0.11 | 3.67E−02 | 0.41 | (↑) | 1.64E−02 | DL-Malic acid |

| | | | | | | | |
|---|---|---|---|---|---|---|---|
| − | 2.32 | 353.09 | 0.73 | 1.09E−02 | 0.05 | 0.43 | Chlorogenic acid^{e} |

^{a}Ion modes defined as positive (+) or negative (−).
^{b}W: wounded sample, U: unwound sample, M: melatonin-treated wounded sample.
^{c}log₂ represents the peak area of wounded samples by the peak area of unwounded samples. Fold changes >0 are listed. (↑) indicates increased compounds and (↓) indicates decreased compounds in melatonin-treated wounded samples compared to wounded samples.
^{d}P-values (<0.05) were calculated using Student's T-test.
^{e}Chlorogenic acid is listed for comparison. Chlorogenic acid only increased in wounded samples compared with unwound samples.

TABLE 3
Selected metabolites that decreased in response to lettuce midrib wounding [log₂(W/U)]
and were affected by melatonin treatment as identified by untargeted LC-MS/MS.

| | Retention | | | | | | | |
|---|---|---|---|---|---|---|---|---|
| Ion | Time | Exact | W/U^{b} | | M/W^{b} | | | Predicted |
| Mode^{a} | (min) | Mass | log₂^{c} | P-value^{d} | log₂^{c} | | P-value^{d} | Compounds |
| + | 0.38 | 134.95 | −8.25 | 9.22E−03 | 7.22 | (↑) | 2.21E−02 | |
| + | 22.43 | 176.98 | −8.1 | 7.93E−03 | 7.51 | (↑) | 3.15E−02 | |
| + | 6.02 | 570.05 | −8.04 | 2.19E−02 | 9.18 | (↑) | 3.03E−02 | |
| − | 8.36 | 337.86 | −7.85 | 1.13E−02 | 8.04 | (↑) | 2.38E−02 | |
| − | 0.85 | 97.97 | −6 | 8.71E−03 | 7.73 | (↑) | 1.48E−04 | |
| + | 33.06 | 397.24 | −4.75 | 3.15E−02 | 4.39 | (↑) | 1.76E−02 | |
| + | 11.4 | 246.13 | −4.29 | 1.36E−03 | 3.22 | (↑) | 9.29E−03 | alpha-Santonin |
| + | 23.59 | 519.33 | −1.36 | 2.18E−02 | 1.45 | (↑) | 1.87E−02 | 1-Linoleoyl-sn- |
| | | | | | | | | glycero-3- |
| | | | | | | | | phosphorylcholine |
| + | 0.62 | 137.06 | −1.35 | 4.72E−02 | 1.86 | (↑) | 4.44E−02 | |
| + | 0.67 | 688.21 | −1.25 | 4.33E−02 | 0.65 | (↑) | 3.66E−02 | |
| + | 4.23 | 598.39 | −0.95 | 8.88E−03 | −0.56 | (↓) | 6.86E−04 | |
| + | 0.65 | 129.05 | −0.95 | 6.96E−03 | 0.9 | (↑) | 4.52E−02 | |
| − | 4.64 | 486.17 | −0.85 | 3.88E−02 | 0.95 | (↑) | 2.21E−02 | |
| + | 21.88 | 517.32 | −0.82 | 4.08E−02 | 1.53 | (↑) | 4.85E−02 | LPC 18:3; PlaSMA |
| | | | | | | | | ID-2744 |
| + | 5.72 | 881.56 | −0.75 | 2.29E−02 | 0.3 | (↑) | 8.99E−03 | |
| + | 5.6 | 459.25 | −0.73 | 2.15E−02 | 0.42 | (↑) | 4.10E−02 | |
| + | 31.73 | 232.9 | −0.71 | 3.58E−02 | −0.33 | (↓) | 1.69E−02 | |
| + | 2.32 | 585.07 | −0.59 | 4.46E−02 | −0.29 | (↓) | 9.36E−03 | |
| + | 2.31 | 1169.12 | −0.55 | 3.48E−02 | −0.38 | (↓) | 1.08E−02 | |
| + | 2.33 | 484.35 | −0.54 | 3.97E−02 | 0.25 | (↑) | 2.82E−02 | |
| + | 2.8 | 144.92 | −0.42 | 1.87E−02 | −7.68 | (↓) | 4.94E−02 | |
| + | 31.62 | 394.22 | −0.39 | 3.78E−02 | −0.46 | (↓) | 1.12E−02 | |
| + | 21.87 | 271.3 | −0.25 | 4.53E−02 | −0.26 | (↓) | 4.17E−02 | |
| + | 29.14 | 613.49 | −0.24 | 8.42E−03 | −0.28 | (↓) | 1.18E−02 | |
| + | 17.12 | 245.86 | −0.24 | 4.62E−02 | −8.39 | (↓) | 4.40E−02 | |

^{a}Ion modes defined as positive (+) or negative (−).
^{b}W: wounded sample, U: unwound sample, M: melatonin-treated wounded sample.
^{c}log₂ represents the peak area of wounded samples by the peak area of unwounded samples. Fold changes <0 are listed. (↑) indicates increased compounds and (↓) indicates decreased compounds in melatonin-treated wounded samples compared to wounded samples.
^{d}P-values (<0.05) were calculated using Student's T-test.

### Example 3: Discussion

### Evaluation of the Severity of the Pink Rib Using RGB Images

When evaluating the severity of the pink rib response in lettuce midribs, it is common to use a visual observation-based system (Monaghan et al., 2016; Paillart et al., 2017; Saltveit, 2004). In this type of system, an observer makes a judgement of the severity of the pink rib response based on their perception of discoloration on the midrib. However, as the accuracy of these methods is dependent upon the ability of an observer to reliably quantify color and the area it occupies, there is potential for human-based error. Visible light imaging has been applied extensively in plant phenomics to measure a variety of phenotypes, including plant color (Yang et al., 2020). Photos taken by a calibrated camera in consistent lighting conditions provide a quantitative measure of the color of the subject. In this study, an imaging-based method was applied for quantifying the severity of the pink rib response in wounded lettuce midribs, which generates results suitable for downstream statistical analysis. Data generated by this method was positively correlated (R²=0.66, P=0.00004) with visual ratings, indicating a possible methodology for objective measurement of pink rib severity (FIGS. 5A-5D). The accessibility of this approach is benefitted by its reliance only on open-source software and the ubiquity and affordability of digital cameras. Moreover, an objective measurement of this disorder could help geneticists to identify minor loci controlling the trait, which is otherwise difficult to detect using subjective ratings.

### Use of Natural Compounds to Reduce Pink Rib Discoloration

Two approaches have been reported in the literature related to attempts to quantify discoloration in fresh lettuce midribs, either by homogenizing tissue with a treatment for direct chemical analysis or by immersing intact tissue in a treatment, monitoring during storage, then processing for chemical analysis. Many treatments have been reported to be slightly effective or completely ineffective in reducing pink rib discoloration, including p-hydroxybenzoic acid, glutathione, ethylenediaminetetracetic acid (EDTA), citric acid (Gawlik-Dziki et al. 2008), NaCl, 4-hexylresorcinol (Hisaminato et al. 2001), 1-methylcyclopropene (Saltveit, 2004), and ethylene (Tomás-Barberán et al. 1997).

In this study, four natural compounds (serotonin, naringenin, L-cysteine and melatonin) were examined for potential to suppress development of pink rib discoloration in two lettuce types during simulated commercial storage. The inhibitory effect of serotonin in fruit discoloration had been previously reported, in which a 30-min submersion in serotonin (1 mM) extended the bright appearance of fresh-cut apple and pear tissues for up to 6 months at 4° C. (Bajwa et al. 2015). However, this study found that serotonin application did not reduce pink rib development in either lettuce type, as serotonin-treated midribs developed “moderate” (iceberg) and “moderately severe” (Romaine) pink rib and yellowing by 5 d in storage at 5° C. (FIG. 6).

Hunter et al. (2017) hypothesized that antioxidant compounds may inhibit oxidation of phenolic compounds and subsequent development of pink rib discoloration. In lettuce, pink rib discoloration was less in water-deficient lettuce, presumably due to an increase in stress-induced antioxidant compounds (Sofo et al. 2005; Oh et al. 2010). Cavia-Saiz et al. (2010) evaluated naringenin (a flavonoid, and as an antioxidant, a free radical scavenger) in vitro for lettuce and reported an increase in antioxidant capacity as measured by ferric reducing antioxidant power (FRAP). However, immersion in up to 3.7 mM of naringenin in the present study did not successfully reduce pink rib as naringenin-treated midribs developed “moderately severe” pink rib in iceberg lettuce after 5 d at 5° C. (FIG. 6).

Like naringenin, L-cysteine is an antioxidant. In iceberg lettuce, L-cysteine (8.3 mM) treatment reduced discoloration of midrib surface area by greater than 80% compared with a control after 6 d at 8° C. (Pace et al. 2015). However, a concentration as high as 0.5% (41.3 mM) had no effect on fresh-cut brown discoloration in fennel (Capotorto et al. 2018) nor artichoke (Cabezas-Serrano et al. 2013). Under the experimental conditions of this study, the application of L-cysteine (4.1 mM) was ineffective in reducing pink rib in iceberg or Romaine lettuce (FIGS. 1A and 1D).

In this study, melatonin (4.3 mM) was the singular treatment that effectively inhibited the pink rib development for 5 d in wounded iceberg midribs and for 3 d in Romaine ribs as compared with wounded control midribs (FIGS. 1A-1F). Similar findings have been reported for melatonin applied to cassava roots (Ma et al. 2016), peach fruit (Gao et al. 2016), and litchi fruit (Zhang et al. 2018). Exogenous application of melatonin (0.1 mM) to cassava pulp delayed development of discoloration (Hu et al. 2016) and activated the antioxidative enzymes that reduce hydrogen peroxide accumulation, thereby delaying senescence (Ma et al. 2016). In peach fruit, melatonin (0.1 mM) delayed senescence, maintained total phenolics, and increased enzyme activity that resulted in inhibited lipid peroxidation (Gao et al. 2016). In melatonin-treated (0.4 mM) litchi fruit, pericarp browning was delayed for 4 d at 25° C., free radical development was reduced, and the activity of several antioxidants was increased (Zhang et al. 2018). For these three tissues (cassava, peach, and litchi), it was hypothesized that exogenous application of melatonin upregulated the expression of key enzymes in the melatonin biosynthesis pathway.

Melatonin has many biological functions in plants, including root architecture, photoprotection, flower development, seed germination, leaf senescence, fruit ripening, vegetative growth, and response to stress (Hu et al. 2016; Shi et al. 2016). It enhances nonenzymatic antioxidants, such as phenolics, flavonoids, and anthocyanins (Boccalandro et al. 2011). It is possible that increasing antioxidant activity in lettuce could reduce pink rib occurrence by disrupting the formation of o-diphenols and o-quinones, the precursors for discoloration pigments.

### Enzyme Activity and Chlorogenic Acid Profile as Affected by Wounding

PAL is a key enzyme associated with pink rib discoloration in lettuce (Hunter et al. 2017); it functions at the entry step of the phenylpropanoid pathway, and its induction leads to formation of phenylpropanoids, with chlorogenic acid as a major phenylpropanoid produced (Tomás-Barberan et al. 1997). In this study, PAL activity and chlorogenic acid concentration were significantly higher in wounded midribs compared with unwounded controls (FIGS. 2A-3B). This is consistent with Campos-Vargas and Saltveit (2002), in which PAL activity in wounded Romaine midribs was approximately 66.7% higher and chlorogenic acid concentrations were 8-fold higher than in unwounded midribs after 5 d at 5° C. This same stress response was also reported by Reyes et al. (2007) in which PAL activity in wounded iceberg lettuce increased ten-fold compared with unwounded tissue (from 0.07 to 0.70 μmol h⁻¹ g⁻¹) after 2 d at 15° C. Concomitantly, these authors found an 81% increase in phenolic content during this same period. In other reports researchers noted how rapid these phenolic biosynthetic reactions occur in lettuce. Total phenolic content in damaged lettuce increased in as soon as 24 h of storage at 4° C. (Cantos et al. 2002); concentrations of specific phenolic compounds and PAL activity increased within 4 h of wounding in iceberg lettuce (Ke and Saltveit 1989). Interestingly, the increase in rate and concentration of PAL activity varies among crops (Reyes et al. 2007), among lettuce cultivars (Teng et al. 2019), and between tissue types; higher PAL activity induction occurred in vascular tissues than in photosynthetic tissues (Fukumoto et al. 2002).

Saltveit (2018a) suggested that PPO catalyzes the combination of o-diphenols, 5-caffeoylquinic acid, 3,5-dicaffeoyltartaric acid, and chlorogenic acid into o-quinones as well as converting caffeic acid into a caffeic acid o-quinone. Since chlorogenic acid has the greatest specificity to PPO in lettuce tissues (Alkunaya and Gokmen, 2008), it was theorized that PPO activity may be related to wounding-induced pink rib discoloration. However, PPO activity was not influenced by wounding in either iceberg or Romaine (FIGS. 4A-4B) lettuce. Similar findings were reported by Teng et al. (2019), in which PPO activity fluctuated from approximately 1 to 5 U throughout 5 d at 5° C., but was not significantly correlated with discoloration. Similarly, PPO activity fluctuated widely after wounding and did not directly correlate with lettuce browning (Chazarra et al. 1996; Hisaminato et al. 2001; Tanaka et al. 2011).

### Enzyme Activity and Chlorogenic Acid Profile Impacted by Natural Compounds

It was previously shown that PPO activity significantly declined in response to L-cysteine. When Ali et al. (2015) immersed circular midrib pieces of iceberg lettuce in L-cysteine (1% or 82.5 mM). PPO activity had significantly declined after 2 d and up to 8 d at 1° C. Gacche et al. (2006) evaluated L-cysteine (1 to 5 mM) in apple flesh and reported a linear decline in PPO activity with increasing L-cysteine concentration. However, it was found that neither PPO activity nor pink rib expression were reduced in response to L-cysteine treatment in iceberg or Romaine midribs (FIGS. 1A-1F and 4A-4B).

Since melatonin was found to be an inhibitor of pink rib in wounded iceberg and Romaine lettuce, it was hypothesized that the inhibitory action occurred through suppression of PAL activity or by formation of chlorogenic acid. Interestingly, it was found that neither enzyme activity (PAL or PPO) nor chlorogenic acid concentration were impacted by an exogenous treatment of melatonin in iceberg or Romaine lettuce (FIGS. 2A-4B). Other researchers have reported that exogenous application of melatonin reduced discoloration in other species. Zhang et al. (2018) evaluated melatonin (0.4 mM)-treated litchi pericarp and found a significant decrease in discoloration and PPO activity up to 6 d and an approximately 40% increase in total phenolics over this same time period. Zheng et al. (2019) evaluated melatonin-treated pear flesh (0.1 mM) and found no inhibition of browning throughout 8 d at 4° C. Meanwhile, PAL activity and total phenolic content were higher in treated pear tissues after 2 and 4 d at 4° C., respectively, and PPO activity was significantly lower after 2 d. Other studies have reported similar correlation between melatonin treatment and enzyme activity and metabolite formation to maintain quality and reduce injury or senescence. Notably, PAL activity and chlorogenic acid concentration increased in melatonin-treated loquat during 25 d storage at 4° C., while maintaining quality and delaying lignification (Wang et al. 2021). Szafrańska et al. (2014) proposed that melatonin regulates phenylpropanoid enzyme activities while Xu et al. (2017) proposed that it acts as a signal to adjust PAL expression. In melatonin-treated peach fruit (Gao et al. 2016) and cassava root (Ma et al. 2016), reactive oxygen species (ROS) levels declined, and antioxidant capacity increased as compared with untreated tissues. Increased antioxidant capacity and decreased ROS may then reduce discoloration due to reduced formation of o-quinone. Upregulation of key enzymes in the melatonin biosynthesis pathway was found in cassava (Ma et al. 2016), strawberry (Liu et al. 2018), and litchi (Zhang et al. 2018). Endogenous melatonin has its own antioxidant capacity but also may act by enhancing nonenzymatic antioxidants such as phenolics, flavonoids, and anthocyanins (Boccalandro et al. 2011).

### Melatonin Treatment Affects Global Metabolite Changes in the Wounded Lettuce Midrib

Untargeted metabolite analysis revealed the altered abundance of various metabolites in wounded samples compared to unwounded samples. Although a few were identified as flavonoids and other known compounds, the rest remains to be determined. It is notable that the majority of compounds which increased or decreased in wounded/pink rib samples displayed a reversal trend upon melatonin application, suggesting that melatonin treatment reduces overall metabolite changes in wounded lettuce midrib. It is plausible that melatonin application may relieve wounding-induced stress responses, which in turn affects metabolite turnover to negate the impacts of pink rib. Further investigation is required to elucidate the mechanisms underlying the inhibitory effects of melatonin in pink rib and other discolorations in lettuce and in other crops.

### Application of Melatonin Delays Pink Rib Discoloration in Lettuce

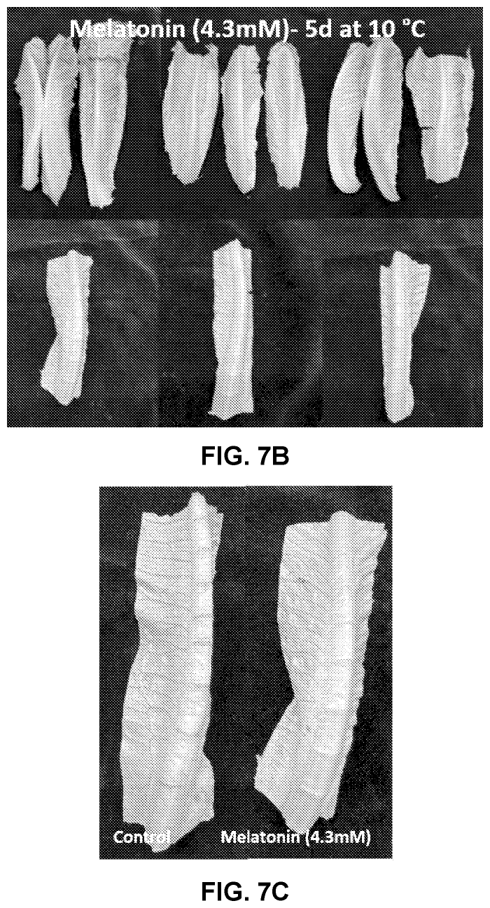

Pink rib discoloration in excised midrib segments of romaine lettuce was shown above. Additionally, pink rib discoloration was tested by including the whole leaflet, as shown in FIGS. 7A-7C. Romaine lettuce midribs treated with 4.3 mM of melatonin for 1 min showed less discoloration when stored at 10° C. for five days compared to control samples. 4.3 mM of melatonin solution was prepared in water containing 0.5% DMSO (dimethyl sulfoxide), and control samples were treated with water containing 0.5% DMSO. This result further confirmed that melatonin reduced pink rib discoloration in romaine lettuce.

### A Lower Concentration of Melatonin is Effective

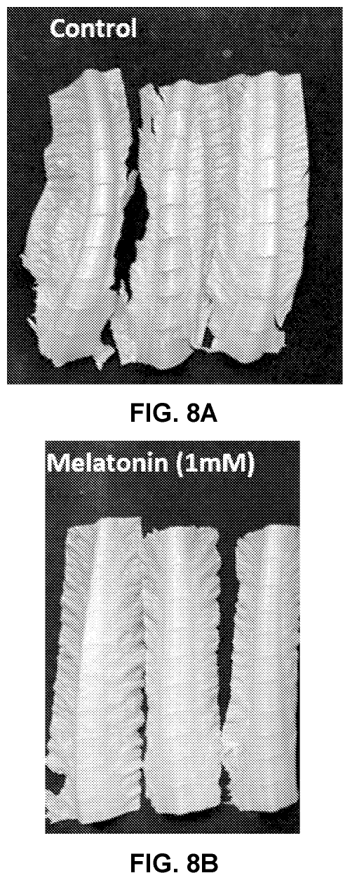

Treatment with a lower melatonin concentration (1 mM) showed similar effectiveness in delaying pink rib discoloration in lettuce. As shown in FIGS. 8A-8B, romaine lettuce midribs dipped with 1 mM of melatonin for 1 min showed less discoloration than control samples after 4 days at 10° C. 1 mM of melatonin solution was prepared in water containing 0.5% DMSO (dimethyl sulfoxide) and control samples were treated with water containing 0.5% DMSO.

### CONCLUSIONS

This study evaluated the severity of pink rib development in iceberg and Romaine lettuce by comparing unwounded midrib tissue with wounded control and wounded midribs treated with selected compounds. Results showed that immersing wounded midribs in a 4.3 mM melatonin solution for 30 s suppressed formation of pink rib discoloration for 5 d in iceberg midribs and for 3 d in Romaine midribs during 5 d storage at 5° C. Enzymatic activity and metabolite concentrations were similar to previous reports for several crops, in which wounding significantly increased PAL activity and chlorogenic acid content, but with no significant change in PPO activity. Exogenous application of melatonin did not significantly affect PAL or PPO enzyme activities nor formation of chlorogenic acid. The untargeted metabolite analysis identified that melatonin application substantially affected wounding-related metabolite changes. Further study is needed to understand the identity and function of these compounds. This study provided insight into melatonin as a potential treatment in response to wounding of lettuce, although the underlying mechanism of melatonin action remains unknown.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Ali, H. M., et al 2015. Browning inhibition mechanisms by cysteine, ascorbic acid and citric acid, and identifying PPO-catechol-cysteine reaction products. J. Food Sci. Technol. 52 (6), 3651-3659.
2. Altunkaya, A. et al. 2008. Effect of various inhibitors on enzymatic browning, antioxidant activity and total phenol content of fresh lettuce (Lactuca sativa). Food Chem. 107, 1173-1179.
3. Altunkaya, A. et al. 2009. Effect of various anti-browning agents on phenolic compounds profile of fresh lettuce (L. sativa). Food Chem. 117 (1), 122-126.
4. Bajwa, V. S. et al. 2015. Identification and characterization of serotonin as an anti-browning compound of apple and pear. Postharvest Biol. Technol. 110, 183-189.
5. Boccalandro, H. E. et al. 2011. Melatonin levels, determined by LC-ESI-MS/MS, fluctuate during the day/night cycle in Vitis vinifera cv Malbec: evidence of its antioxidant roles in fruits. J. Pineal Res. 51, 226-232.
6. Cabezas-Serrano, A. B. et al. 2013. Effect of solution pH of cysteine-based pre-treatments to prevent browning of fresh-cut artichokes. Postharvest Biol. Technol. 75, 17-23.
7. Campos-Vargas, R., et al. 2008. Effect of harvest time and L-cysteine as an antioxidant on flesh browning of fresh-cut cherimoya (Annona cherimola Mill.). Chilean J Agric. Res. 68 (3), 217-227.
8. Campos-Vargas, R. et al 2002. Involvement of putative chemical wound signals in the induction of phenolic metabolism in wounded lettuce. Physiologia plantarum 114 (1), 73-84.
9. Cantos, J. A., et al. 2002. Phenolic compounds and related enzymes are not rate-limiting in browning development of fresh-cut potatoes. J. Agric. Food Chem. 50, 3015-3023.
10. Capotorto, I., et al. 2018. Effect of anti-browning solutions on quality of fresh-cut fennel during storage. Postharvest Biol. Technol. 137, 21-30.
11. Cantwell, M. 2016. Postharvest Physiological Disorders: Pinking in Romaine Hearts. California Leafy Greens Research Program. <<http://calgreens.org/wp-content/uploads/2016/06/Pinking-in-Romaine-Hearts-Cantwell.pdf>accessed Nov. 2, 2022.
12. Cavia-Saiz, M., et al. 2010. Antioxidant properties, radical scavenging activity and biomolecule protection capacity of flavonoid naringenin and its glycoside naringin: a comparative study. J. Sci. Food Agric. 90 (7), 1238-1244.
13. Chazarra, S., et al. 1996. Partial purification and characterization of latent polyphenol oxidase in iceberg lettuce (Lactuca sativa L.). J. Agric. Food Chem. 44, 984-988.
14. Chiesa, A. 2003. Factors determining postharvest quality of leafy vegetables. In: Tijskens L M M et al (eds.) Proceedings of the international conference on quality in chains: An integrated view on fruit and vegetable quality. Acta Horticulture, 604:519-524.
15. Couture, R, et al. 1993. Physiological attributes related to quality attributes and storage life of minimally processed lettuce. HortScience 28, 723-725.
16. FAOSTAT. Data. 2020. <<https://www.fao.org/faostat/en/#data>accessed Nov. 2, 2022.
17. Fukumoto, L. R., et al. 2002. Effect of wash water temperature and chlorination on phenolic metabolism and browning of stored iceberg lettuce photosynthetic and vascular tissues. J. Agric. Food Chem. 50, 4503-4511.
18. Gacche, R. N., et al. 2006. Reversible inhibition of polyphenol oxidase from apple using L-cysteine. Indian J. Chem. Technol. 13, 459-463.
19. Gao, H., et al. 2016. Melatonin treatment delays postharvest senescence and regulates reactive oxygen species metabolism in peach fruit. Postharvest Biol. Technol. 118, 103-110.
20. Gawlik-Dziki, U., et al. 2008. Characterization of polyphenol oxidase from butter lettuce (Lactuca sativa var. capitata L.). Food Chem. 107 (1), 129-135.
21. Hapiot, P., et al. 1996. Oxidation of caffeic acid and related hydroxycinnamic acids. J. Electroanalytical Chem. 405 (1-2), 169-176.
22. Hilton, H. W., et al. 2009. The influence of agronomic factors on the visual quality of field-grown, minimally-processed lettuce. J. Hort. Sci. Biotechnol. 84 (2), 193-198.
23. Hisaminato, H., et al. 2001 Relationship between enzymatic browning and phenylalanine ammonia lyase activity of cut lettuce, and the prevention of browning by inhibitors of polyphenol biosynthesis. Biosci. Biotechnol. Biochem. 65, 1016-1021.
24. Hu, W., et al. 2016. Comparative physiological and transcriptomic analyses reveal the actions of melatonin in the delay of postharvest physiological deterioration of cassava. Frontiers Plant Sci. 7, 736.
25. Hunter, P. J., et al. 2017. Oxidative discolouration in whole-head and cut lettuce: biochemical and environmental influences on a complex phenotype and potential breeding strategies to improve shelf-life. Euphytica 213 (8), 1-16.
26. Jenni, S. 2005. Rib discoloration: A physiological disorder induced by heat stress in crisphead lettuce. HortScience 40 (7), 2031-2035.
27. Ke, D. et al. 1989. Wound-induced ethylene production, phenolic metabolism and susceptibility to russet spotting in iceberg lettuce. Physiologia Plantarum 76 (3), 412-418.
28. Kim, J. I., et al. 2020. Glucosinolate and phenylpropanoid biosynthesis are linked by proteasome-dependent degradation of PAL. New Phytologist 225 (1), 154-168.
29. Lei, Z., et al. 2018. Construction of an ultrahigh pressure liquid chromatography-tandem mass spectral library of plant natural products and comparative spectral analyses. Anal. Chem. 87:7373-7381.
30. Liu, C., et al. 2018. Effects of melatonin treatment on the postharvest quality of strawberry fruit. Postharvest Biol. Technol. 139, 47-55.
31. López-Galvez, G., et al. 1996a. The visual quality of minimally processed lettuces stored in air or controlled atmosphere with emphasis on romaine and iceberg types. Postharvest Biol. Technol., 8, 179-190.
32. López-Galvez, G., et al. 1996b. Wound-induced phenylalanine ammonia-lyase activity: factors affecting its induction and correlation with the quality of minimally processed lettuces. Postharvest Biol. Technol. 9, 223-233.
33. Luna, M. C., et al 2016. Modified atmosphere (MA) prevents browning of fresh-cut romaine lettuce through multi-target effects related to phenolic metabolism. Postharvest Biol. Technol. 119, 84-93.
34. Ma, Q., et al. 2016 Melatonin attenuates postharvest physiological deterioration of cassava storage roots. J. Pineal Res. 60, 424-434.
35. Monaghan, J. M., et al. 2017. Deficit irrigation reduces postharvest rib pinking in whole-head Iceberg lettuce, but at the expense of head fresh weight. J. Sci. Food Agricul. 97 (5), 1524-1528.
36. Oh, M. M., et al. 2010. Regulated water deficits improve phytochemical concentration in lettuce. J. Amer. Soc. Hort. Sci. 135 (3), 223-229.
37. Pace, B., et al. 2015. Evaluation of L-cysteine as anti-browning agent in fresh-cut lettuce processing. J. Food Process. Preser. 39 (6), 985-993.
38. Paillart, M. J. M., et al. 2017. Effect of mild heat-shock treatments on pink discoloration and physiological parameters in fresh-cut iceberg lettuce. LWT-Food Sci. Technol. 85, 456-459.
39. Pereyra, L., et al. 2005. Phenylalanine ammonia lyase activity in minimally processed Romaine lettuce. LWT-Food Sci. Technol. 38 (1), 67-72.
40. Pierpoint, W. S., 1969. O-Quinones formed in plant extracts. Their reactions with amino acids and peptides. Biochem. J. 112, 609-616.
41. R Core Team. 2020. R: A language and environment for statistical computing. R Foundation for Statistical Computing, Vienna, Austria.
42. Rawel, H. M. et al. 2010. Nature of hydroxycinnamate-protein interactions. Phytochem. Rev. 9 (1), 93-109.
43. Reyes, L. F., et al. 2007. The increase in antioxidant capacity after wounding depends on the type of fruit or vegetable tissue. Food Chem. 101 (3), 1254-1262.
44. Saltveit, M. E. 2004. Effect of 1-methylcyclopropene on phenylpropanoid metabolism, the accumulation of phenolic compounds, and browning of whole and fresh-cut ‘iceberg’ lettuce. Postharvest Biol. Technol. 34 (1), 75-80.
45. Saltveit, M. E. et al. 2008. Heating the ends of leaves cut during coring of whole heads of lettuce reduces subsequent phenolic accumulation and tissue browning. Postharvest Biol. Technol. 47 (2), 255-259.
46. Saltveit, M. E., et al. 2005. Involvement of components of the phospholipid-signaling pathway in wound-induced phenylpropanoid metabolism in lettuce (Lactuca sativa) leaf tissue. Physiol. Plant 125 (3), 345-355.
47. Saltveit, M. E. 2018a. Pinking of lettuce. Postharvest Biol. Technol. 145, 41-52.
48. Saltveit, M. E. 2018b. Anaerobic exposure before or after wounding reduces the production of wound-induced phenolic compounds in fresh-cut lettuce. Postharvest Biol. Technol. 135, 77-82.
49. Shi, H., et al. 2016. Fundamental issues of melatonin-mediated stress signaling in plants. Frontiers Plant Sci. 7, 1124.
50. Sofo, A, et al. 2005. Antioxidant defences in olive trees during drought stress: changes in activity of some antioxidant enzymes. Func. Plant Biol. 32, 45-53.
51. Szafrańska, K., et al 2014. Involvement of melatonin applied to Vigna radiata L. seeds in plant response to chilling stress. Open Life Sci. 9 (11), 1117-1126.
52. Tanaka, E., et al. 2011. Cinnamaldehyde inhibits enzymatic browning of cut lettuce by repressing the induction of phenylalanine ammonia-lyase without promotion of microbial growth. J. Agric. Food Chem. 59, 6705-6709.
53. Teng, Z., et al. 2019. Identification of romaine lettuce (Lactuca sativa var. longifolia) cultivars with reduced browning discoloration for fresh-cut processing. Postharvest Biol. Technol. 156, 110931.
54. Toivonen, P. et al. 2008. Biochemical bases of appearance and texture changes in fresh-cut fruit and vegetables. Postharvest Biol. Technol. 48, 1-14.
55. Tomás-Barberán F. A., et al 1997. Early wound- and ethylene-induced changes in phenylpropanoid metabolism in harvested lettuce. J. Amer. Soc. Hort. Sci. 122, 399-404.
56. Wang, D., et al. 2021. Melatonin treatment maintains quality and delays lignification in loquat fruit during cold storage. Scientia Horticulturae 284, 110126.
57. Xu, L., et al. 2017. Melatonin enhances phenolics accumulation partially via ethylene signaling and resulted in high antioxidant capacity in grape berries. Frontiers Plant Sci. 8, 1426.
58. Yang, W., et al. 2020. Crop Phenomics and High-Throughput Phenotyping: Past Decades, Current Challenges, and Future Perspectives. Mol. Plant 13, 187-214.
59. Yin, R., et al. 2012. Feedback inhibition of the general phenylpropanoid and flavonol biosynthetic pathways upon a compromised flavonol-3-O-glycosylation. J Expt. Botany 63 (7): 2465-2478.
60. Zhang, Y., et al. 2018. Delay of postharvest browning in litchi fruit by melatonin via the enhancing of antioxidative processes and oxidation repair. J. Agr. Food Chem. 66 (28), 7475-7484.
61. Zheng, H., et al. 2019. Effects of melatonin treatment on the enzymatic browning and nutritional quality of fresh-cut pear fruit. Food Chem. 299, 125116.

1. A method for reducing or delaying pink rib discoloration in lettuce, the method comprising contacting the lettuce with a composition comprising melatonin.

2. The method of claim 1, wherein the lettuce comprises Romaine lettuce, Butterhead lettuce, or iceberg lettuce.

3. The method of claim 1, wherein the composition comprises from about 1.0 mM to about 5.7 mM of melatonin.

4. (canceled)

5. The method of claim 1, wherein the composition further comprises DMSO.

6. The method of claim 5, wherein the composition comprises 0.5 vol % DMSO.

7. The method of claim 1, wherein contacting the lettuce with the composition comprises immersing the lettuce in the composition, spraying the lettuce with the composition, pouring the composition over the lettuce, or any combination thereof.

8. The method of claim 7, wherein the lettuce is immersed in the composition for up to about 60 seconds.

9. The method of claim 1, wherein the method reduces or delays pink rib discoloration for from about 3 to about 5 days.

10. The method of claim 9, wherein the lettuce is iceberg lettuce and the method reduces or delays pink rib discoloration for about 5 days.

11. The method of claim 9, wherein the lettuce is Romaine lettuce and the method reduces or delays pink rib discoloration for about 3 days.

12. The method of claim 1, wherein the method further comprises storing the lettuce at from about 5 to about 25° C. after contacting the lettuce with the composition.

13. The method of claim 1, wherein the method further comprises storing the lettuce at 95-98% relative humidity after contacting the lettuce with the composition.

14. The method of claim 1, wherein the method is performed at from about 4 hours to about 3 days following harvest of the lettuce.

15. The method of claim 1, wherein performing the method results in a magnitude of increase in a* value in L*a*b* color space in a digital image of a cut surface of the lettuce of less than about 6 after 5 days when compared to a digital image of the lettuce prior to performing the method.

16. The method of claim 15, wherein the lettuce is iceberg lettuce and the magnitude of increase in a* value is less than about 1 after 5 days.

17. The method of claim 15, wherein the lettuce is Romaine lettuce and the magnitude of increase in a* value is less than about 5.5 after 5 days.

18. The method of claim 15, wherein a final a* value after performing the method is less than about 1.5.

19. The method of claim 1, wherein performing the method reduces formation of o-diphenols, o-quinones, or both.

20. A method for assessing pink rib discoloration in cut lettuce surfaces, the method comprising:
(a) acquiring a digital image of a cut lettuce surface;
(b) extracting an RGB color value from one or more isolated pixels in the digital image;
(c) converting the RGB color value to an L*a*b* color value; and
(d) extracting an a* value from the L*a*b* color value;
wherein a positive a* value indicates pink rib discoloration is present.

21. The method of claim 20, wherein a higher magnitude a* value indicates a greater degree of pink rib discoloration.
